(19) United States
(12) Patent Application Publication
(10) Pub. No.: US 2024/0419571 A1
(43) Pub. Date: Dec. 19, 2024

(54) RESOURCE LIMITS SPECIFICATION FOR CONTAINER ORCHESTRATION SYSTEM

(71) Applicant: Telefonaktiebolaget LM Ericsson (publ), Stockholm (SE)

(72) Inventors: Gianmarco BRUNO, Genova (IT); Sabrina LETTERE, Genova (IT)

(21) Appl. No.: 18/703,438

(22) PCT Filed: Oct. 22, 2021
(86) PCT No.: PCT/EP2021/079426

§ 371 Date: Apr. 22, 2024

(51) Int. Cl. G06F 11/34; G06F 9/50

(52) U.S. Cl. CPC G06F 11/3433; G06F 9/5077; G06F 2209/504

(57) ABSTRACT

A method, system and apparatus are disclosed. A network node configured to manage a lifecycle of a container configurable to run on the network node is described. The network node includes a communication interface configured to receive a container operation configuration. The container operation configuration includes a first container operation configuration and a second container operation configuration. The first container operation configuration includes a first upper resource limit. The second container operation configuration includes a second upper resource limit. The network node also includes processing circuitry in communication with the communication interface and configured to determine a maximum resource limit associated with a network node resource usable by the container to run on the network node based at least in part on a first mode of container operation, a second mode of container operation, and the received container operation configuration.

### TECHNICAL FIELD

The present disclosure relates to service orchestration and life cycle management systems, and in particular, to resource limits for orchestration systems.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

Communication service providers depend on software applications such as 5G Core and Mobile Edge in large-scale software deployments to provide services associated with 5G wireless communication systems. The software applications are typically designed according to “cloud-native” principles, which allows for the software applications, e.g., 5G Core and Mobile Edge, to be split into a multitude of microservices. The large-scale software deployments are typically based on container orchestration platforms

Kubernetes is a container orchestration platform that is a portable, extensible, open-source platform and is used for managing containerized workloads and services. Kubernetes facilitates declarative configuration and automation and has a large, rapidly growing ecosystem. In addition, Kubernetes services, support, and tools are widely available.

In Kubernetes, computational workloads are managed into pods which are the minimal manageable unit. Kubernetes schedules pods to run on Kubernetes worker nodes. Further, a pod represents a set of one or more running containers. A container is a lightweight and portable running image that contains software implementing a business logic and its dependencies.

There are Kubernetes clusters made of multiple nodes such as worker nodes (e.g., network nodes) in a core network, and others optimized for low footprint to host functions close to a network edge and/or access networks.

An operator, such as a DevOps engineer, (i.e., a person responsible for maintenance of containers in a Kubernetes environment) associates constraints related to memory (e.g., Random Access Memory (RAM)) and Central Processing Unit (CPU) to every container, e.g., to strike a balance between workload performance and total footprint. The operator seeks to minimize total footprint without compromising software application performance to have a competitive offer and reduce computing requirements (e.g., of bare-metal or virtualized systems) and power consumption. When the operator deploys a workload into Kubernetes, a “scheduler” component is responsible for allocation of the relevant pod(s) to the nodes looking at computational constraints including CPU and memory.

A “kubelet” is an agent that runs on each node in the cluster and makes sure that containers are running in a pod as desired. The kubelet may be considered to manage the lifecycle of a container (and/or pod) in the worker node and relies on a “container runtime” (e.g., docker or containerd) to start and stop containers.

Further, Kubernetes exposes two ways to model CPU and memory constraints: “requests” and “limits.” Requests are a minimal amount of resources that must be present in a worker node, e.g., a network node, to allow a pod (and/or container) to be scheduled on the worker node. The pod (and/or container) is allocated by the scheduler to the worker node only if the worker node has an available CPU/RAM greater than a resource request (e.g., a resource request associated with a pod and/or container).

Limits are a maximum (and/or minimum) amount of resources allowed to be consumed by a pod (and/or container). When a pod (and/or container) is scheduled to a worker node, the CPU/RAM requests associated with the pod (computed from its containers) are deducted from respective available total CPU/RAM on worked the node.

CPU/RAM limits have these effects on behavior of the pod/container though slight variations might occur:
When the pod/container claims more memory than a memory limit, e.g., a RAM limit, the pod/container is sent an “OOMKill” (Out Of Memory Kill) and is restarted.
CPU limit instead acts as throttling, which might seem less harmful than restarting a pod/container as described above. However, CPU limits and/or throttling impact service readiness and, in case of certain loads, even service availability, thereby having cascading negative effects.

According to the state-of-the-art, resource requests and limits are constants along the life of a container. However, typically at startup, containers have a maximum CPU consumption while at runtime containers consume much less (sometime negligible) CPU than at startup. RAM consumption is not constant and, apart garbage collections (e.g., when supported by certain systems), goes with the number of loaded data structures, plugins, etc., on top of a fixed amount. Indicative time plots of CPU usage and memory usage, such as RAM usage, are shown in FIG. 1.

Further, when a CPU resource limit is configured for a container, the container cannot use more CPU than the configured limit. However, during a startup phase the container might benefit from using more than the configured limit, and hence the container is slowed down. In addition, assessing a CPU demand of application (i.e., made of multiple containers) may not be assessed, in part due to the configured limits. As a result, CPU resource limit for all phases is typically configured based on demands that correspond to startup demands (i.e., typically much higher than at runtime), thereby configuring the limits for runtime at a much greater limit than needed which leads to underutilized resources.

### SUMMARY

Some embodiments advantageously provide methods, systems, and apparatuses for augmenting a container resource model with configuration parameters that describe container resource consumption during startup phase and/or runtime phase. A container as described in the present disclosure may refer to a pod, such as a Kubernetes pod and/or a Kubernetes container and/or any other container. In some other embodiments, a container orchestration control plane is configurable to determine the container is still in a startup phase by measuring probe information, e.g., readiness probe information, from one or more probes. Once the container has achieved a desired state, lower resource limits can be applied, e.g., such that a fraction of node resources allocated to the container are released and ready to be allocated at least to other containers. In an embodiment, a distinction between a temporary (e.g., higher) demand for CPU (e.g., at startup) and a long term (e.g., lower) demand for CPU at runtime can be made.

In another embodiment, a resource model (e.g., a container resource model (API)) is enriched with configuration parameters which can be optionally a function of workload status. The workload status may be and/or be based on probe information, such as probe information obtained from a readiness probe and/or a startup probe and/or any other probe. In another embodiment, if the configuration parameters are not present, other configuration parameters from the corresponding resource limits may be used.

The embodiments of the present disclosure improve typical node utilization by improving at least return of investment (i.e., more work done for used resources) and provide compatibility with legacy applications deployed in a cluster. By allowing extra resources in the startup phase, the container gets ready faster than typical containers and services associated with the container are more responsive and/or resilient than services associated with typical containers. Increased resilience is evident by faster startup in case of pod eviction, node shutdown, etc. Conditional blocks in application descriptors (e.g., Helm charts) may be used and/or provided to engineers. Further, infringement detection (i.e., detecting when limits are exceeded) is straightforward by observing container APIs, e.g., supported by the cluster.

According to an aspect of the present disclosure, a network node configured to manage a lifecycle of a container configurable to run on the network node is described. The network node comprises a communication interface configured to receive a container operation configuration. The container operation configuration includes a first container operation configuration and a second container operation configuration. The first container operation configuration includes a first upper resource limit, and the second container operation configuration includes a second upper resource limit. The network node also includes processing circuitry in communication with the communication interface, where the processing circuitry is configured to determine a maximum resource limit associated with a network node resource usable by the container to run on the network node based at least in part on a first mode of container operation, a second mode of container operation, and the received container operation configuration.

In some embodiments, the first mode of container operation is a startup phase of the container, and the second mode of container operation is a runtime phase of the container.

In some other embodiments, the processing circuitry is further configured to determine that the container is operated in any one of the first mode of container operation and the second mode of container operation based, at least in part, on probe information.

In an embodiment, the processing circuitry is further configured to determine that the maximum resource limit equals any one of the first upper resource limit of the first container operation configuration when the container is operated in the first mode of container operation; and the second upper resource limit of the second container operation configuration when the container is operated in the second mode of container operation. The first upper resource limit is one of equal to and greater than the second upper resource limit.

In another embodiment, the second mode of container operation causes at least a portion of the network node resource usable by the container during the first mode of container operation to become available.

In some embodiments, the container operation configuration is part of a modified container resource model.

In some other embodiments, the processing circuitry is further configured to manage the lifecycle of the container based on the determined maximum resource limit. Managing the lifecycle of the container includes any one of starting the container and running the container.

In an embodiment, the network node resource usable by the container to run on the network node includes any one of a processor and a memory.

In another embodiment, the container is associated with a pod.

In some embodiments, the network node is a Kubernetes kubelet running on a Kubernetes worker node, the network node resource is a node resource associated with the Kubernetes worker node, and the container is configured by a Kubernetes scheduler to run on the network node.

According to another aspect, a method implemented in a network node configured to manage a lifecycle of a container configurable to run on the network node is described. The method includes receiving a container operation configuration, the container operation configuration including a first container operation configuration and a second container operation configuration. The first container operation configuration includes a first upper resource limit, and the second container operation configuration includes a second upper resource limit, The method further includes determining a maximum resource limit associated with a network node resource usable by the container to run on the network node based at least in part on a first mode of container operation, a second mode of container operation, and the received container operation configuration.

In some embodiments, the first mode of container operation is a startup phase of the container, and the second mode of container operation is a runtime phase of the container.

In some other embodiments, the method further includes determining that the container is operated in any one of the first mode of container operation and the second mode of container operation based, at least in part, on probe information.

In an embodiment the method further includes determining that the maximum resource limit equals any one of the first upper resource limit of the first container operation configuration when the container is operated in the first mode of container operation; and the second upper resource limit of the second container operation configuration when the container is operated in the second mode of container operation. The first upper resource limit being one of equal to and greater than the second upper resource limit.

In another embodiment, the second mode of container operation causes at least a portion of the network node resource usable by the container during the first mode of container operation to become available.

In some embodiments, the container operation configuration is part of a modified container resource model.

In some other embodiments, the method further includes managing the lifecycle of the container based on the determined maximum resource limit, managing the lifecycle of the container including any one of starting the container and running the container.

In an embodiment, the network node resource usable by the container to run on the network node includes any one of a processor and a memory.

In another embodiment, the container is associated with a pod.

In some embodiments, the network node is a Kubernetes kubelet running on a Kubernetes worker node, the network node resource is a node resource associated with the Kubernetes worker node, and the container is configured by a Kubernetes scheduler to run on the network node.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows typical time plots for CPU and RAM.

FIG. 2 is a schematic diagram of an example network architecture illustrating a communication system connected via an intermediate network to a host computer according to the principles in the present disclosure:

FIG. 3 is a block diagram of a host computer communicating via a network node with a wireless device over an at least partially wireless connection according to some embodiments of the present disclosure:

FIG. 4 is a flowchart illustrating example methods implemented in a communication system including a host computer, a network node and a wireless device for executing a client application at a wireless device according to some embodiments of the present disclosure:

FIG. 5 is a flowchart illustrating example methods implemented in a communication system including a host computer, a network node and a wireless device for receiving user data at a wireless device according to some embodiments of the present disclosure:

FIG. 6 is a flowchart illustrating example methods implemented in a communication system including a host computer, a network node and a wireless device for receiving user data from the wireless device at a host computer according to some embodiments of the present disclosure:

FIG. 7 is a flowchart illustrating example methods implemented in a communication system including a host computer, a network node and a wireless device for receiving user data at a host computer according to some embodiments of the present disclosure:

FIG. 8 is an example Kubernetes architecture including a kubelet configured to determine a resource limit associated a network node resource usable by a container to run on the network node 16.

FIG. 9 is a flowchart of an example process in a network node for determining a maximum resource limit associated with a network node resource usable by a container to run on the network node according to some embodiments of the present disclosure; and

FIG. 10 is a time plot showing an example resource limit being assigned to a CPU during a first mode of container operation and another resource limit being assigned to the CPU during a second mode of container operation according to some embodiments of the present disclosure.

### DETAILED DESCRIPTION

Before describing in detail example embodiments, it is noted that the embodiments reside primarily in combinations of apparatus components and processing steps related to resource limits specification for a container orchestration system. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising.” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node, including but not limited to nodes in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

Further, a network node may comprise and/or run any element of an orchestration system, including a container orchestration system, e.g., Kubernetes. More specifically, a network node may include and/or be any element of an orchestration system such as a Kubernetes cluster, an Application Programming Interface (API) server, a cloud provider API, a cloud controller manager, a controller manager, an etcd (i.e., a consistent and highly-available key value store used as Kubernetes' backing store for all cluster data, persistence store, etc.), a kubelet (e.g., a Kubernetes kubelet), a kube-proxy, a pod (e.g., a Kubernetes pod), a container (e.g., a Kubernetes container), a scheduler, a control plane, and a worker node (e.g., a Kubernetes worker node). Put differently, any of the elements of the orchestration system may include elements of a Kubernetes system and/or elements from any other system and may be part of and/or be run by the network node. Further, the network node may have at least a network function running on hardware (e.g., for performance) and/or at least some other network function running in a container orchestration system (e.g., Kubernetes) such as for scalability and/or resilience.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular system, such as, for example, 3GPP LTE and/or New Radio (NR), may be used in this disclosure, this should not be seen as limiting the scope of the disclosure to only the aforementioned system. Other systems, including without limitation any container orchestration system, e.g., Kubernetes, may also benefit from exploiting the ideas covered within this disclosure.

Note further, that functions described herein as being performed by a wireless device or a network node may be distributed over a plurality of wireless/wired devices and/or network nodes. In other words, it is contemplated that the functions of the network node and wireless device described herein are not limited to performance by a single physical device and, in fact, can be distributed among several physical devices. In one embodiment, any network node may be in direct/indirect communication such as wired/wireless communication with another network node.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide determine a maximum resource limit associated with a network node resource usable by a container to run on a network node based at least in part on a first mode of container operation, a second mode of container operation, and/or a received container operation configuration. The maximum resource limit may be a resource limit that is determined/specified such that the usage of a resource is not exceeded and/or reached and/or not maintained. The maximum resource limit may include any limit and may be a variable/constant that is assigned a value, e.g., the value of any one of a first upper resource limit, a second upper resource limit, and/or any other limit.

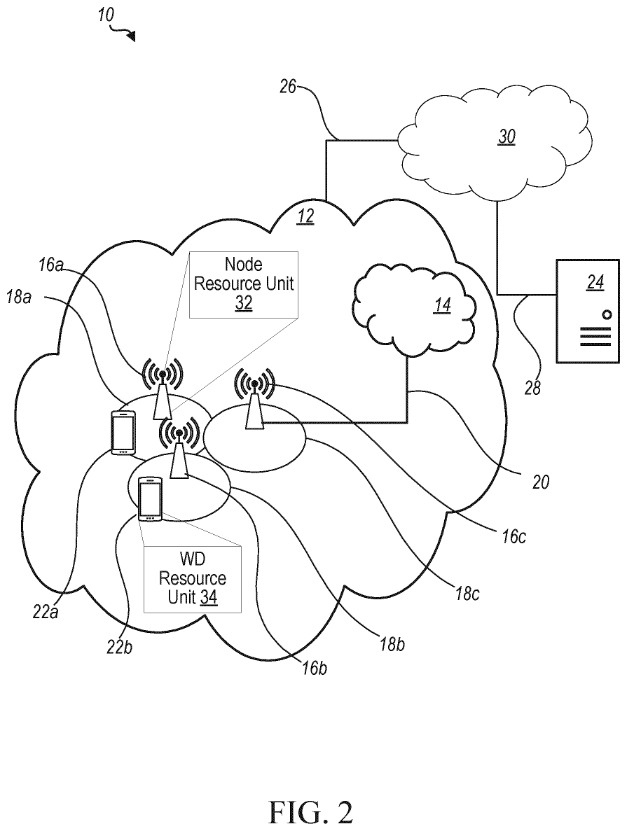

Referring again to the drawing figures, in which like elements are referred to by like reference numerals, there is shown in FIG. 2 a schematic diagram of a communication system 10, according to an embodiment, which comprises an access network 12, such as a radio access network, and a core network 14. Any one of access network 12 and core network 14 may refer to a network and/or a network component associated with a container orchestration system. The access network 12 comprises a plurality of network nodes 16a, 16b, 16c (referred to collectively as network nodes 16), such as any a component of a container orchestration system, NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN. Similarly, it is contemplated that a network node 16 can be in simultaneous communication and/or configured to separately communicate with more than one network node 16 and more than one type of network node 16.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a node resource unit 32 which is configured to determine a maximum resource limit associated with a network node resource that is usable by a container to run on the network node based at least in part on a first mode of container operation, a second mode of container operation, and a received container operation configuration. A wireless device 22 is configured to include a WD resource unit 34 which is configured to perform any of the steps/methods/features described in the present disclosure.

Although communication system 10 of FIG. 2 has been described with respect to a 3GPP-type cellular network and/or wireless devices and/or wireless communication, communication system 10 is not limited as such and may be any other system, e.g., any container orchestration system such as Kubernetes.

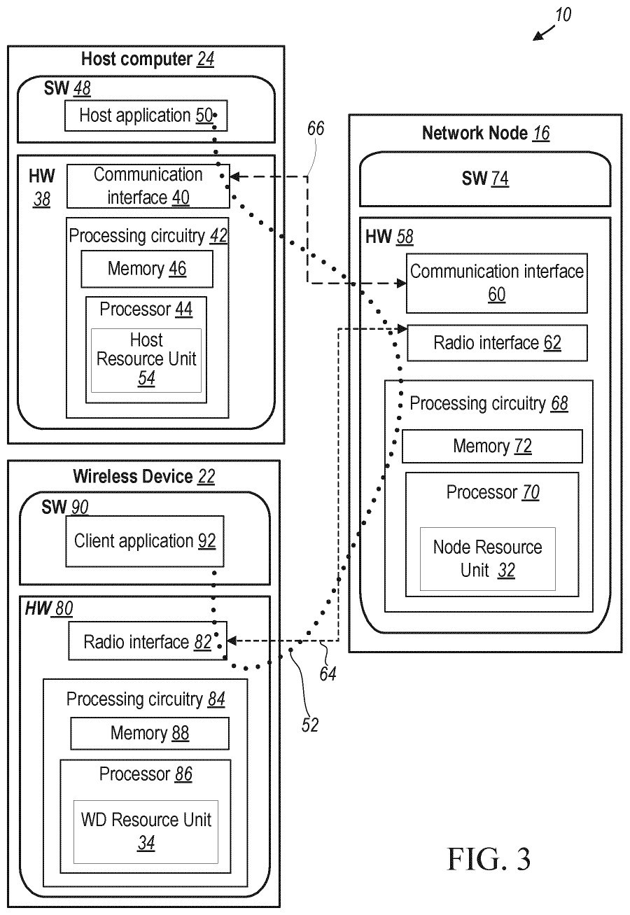

Example implementations, in accordance with an embodiment, of the WD 22, network node 16 and/or host computer 24 discussed in the preceding paragraphs will now be described with reference to FIG. 3. In a communication system 10, e.g., a container orchestration system, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a host resource unit 54 configured to enable the service provider to observe/monitor/control/transmit to/receive from the network node 16 and or the wireless device 22 and/or perform any steps/methods/features described in the present disclosure.

The communication system 10.g, a container orchestration system, further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10 and/or another network node 16, as well as a radio interface 62 for setting up and maintaining at least a wireless connection 64 with a WD 22 located in a coverage area 18 served by the network node 16 and/or another network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include node resource unit 32 configured to determine a maximum resource limit associated with a network node resource that is usable by the container to run on the network node 16 based at least in part on a first mode of container operation, a second mode of container operation, and a received container operation configuration.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD resource unit 34 configured to perform any of the methods/steps/features of the present disclosure.

In some embodiments, the inner workings of the network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes: the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.: the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16. Although communication system 10 of FIG. 3 has been described with respect to a 3GPP-type cellular network and/or wireless devices and/or wireless communication, communication system 10 is not limited as such and may be any other system, e.g., any container orchestration system such as Kubernetes.

Although FIGS. 2 and 3 show various “units” such as node resource unit 32, and WD resource unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

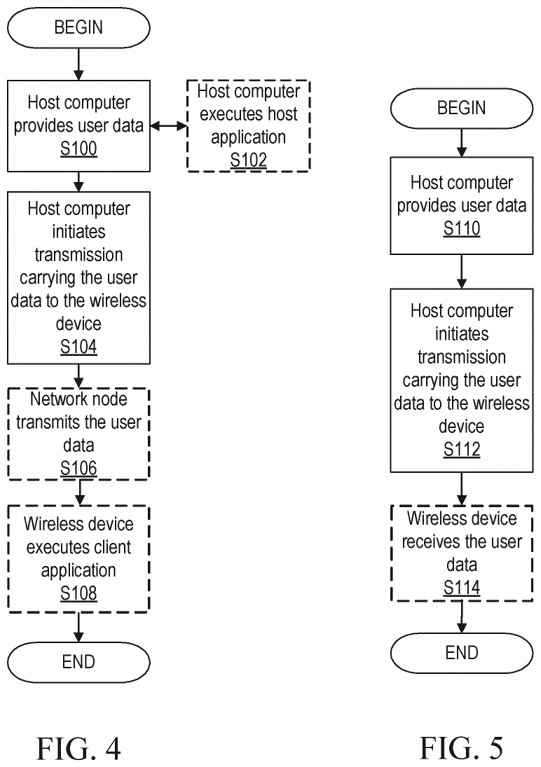

FIG. 4 is a flowchart illustrating an example method implemented in a communication system, such as, for example, the communication system of FIGS. 2 and 3 which may be a container orchestration system, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

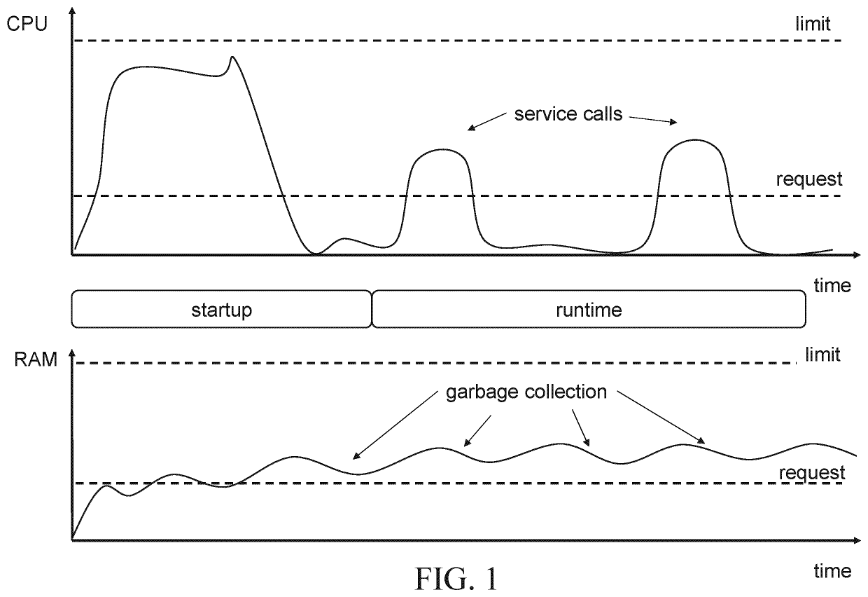

FIG. 5 is a flowchart illustrating an example method implemented in a communication system, such as, for example, the communication system of FIG. 2 which may be a container orchestration system, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

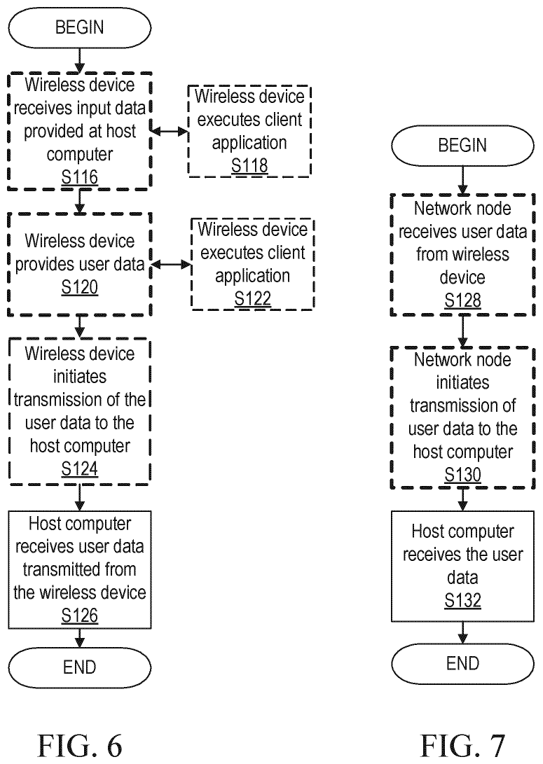

FIG. 6 is a flowchart illustrating an example method implemented in a communication system, such as, for example, the communication system of FIG. 2 which may be a container orchestration system, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an example method implemented in a communication system, such as, for example, the communication system of FIG. 2 which may be a container orchestration system, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

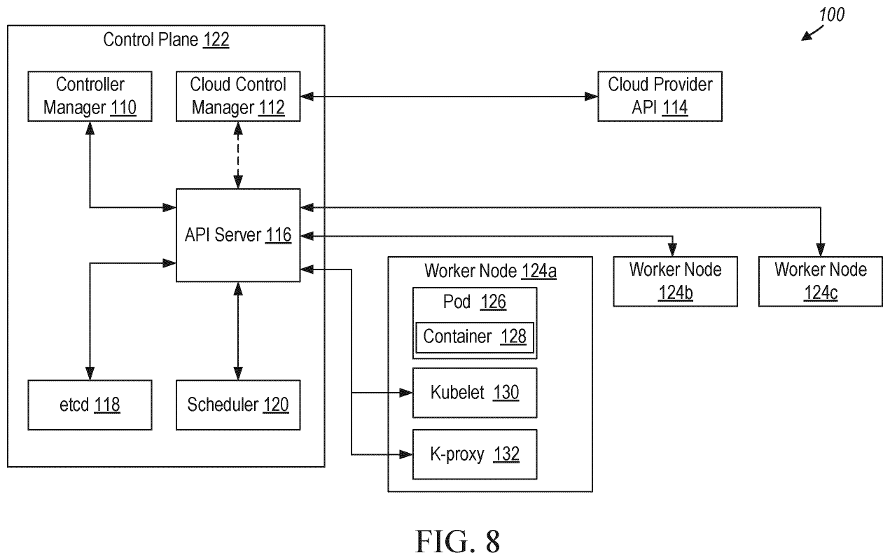

FIG. 8 is an example Kubernetes architecture including a kubelet configured to determine a resource limit (e.g., a maximum resource limit) associated with a network node resource usable by a container to run on the network node 16, e.g., via processing circuitry 68. The Kubernetes architecture may include Kubernetes elements (i.e., elements of an orchestration system) such as a cluster 100 (i.e., a Kubernetes cluster), a controller manager 110, a cloud control manager 112, a cloud provider API 114 (i.e., an API), an API server 116, an etcd 118 (i.e., a consistent and highly-available key value store used as Kubernetes' backing store for all cluster data, persistence store, etc.), and a scheduler 120. Any one of the controller manager 110, the cloud control manager 112, the API server 116, the etcd 118, and/or the scheduler 120 may be included in or part of control plane 122. Further, the Kubernetes architecture may include one or more worker nodes 124 (i.e., Kubernetes nodes, Kubernetes worker nodes, etc.), where the worker nodes may be part of the cluster 100. As shown in FIG. 8, the worker nodes 124 include worker node 124a, worker node 124b, and worker node 124c, but are not limited to including three worker nodes 124 and may be any number of worker nodes 124. Each worker node 124 may include one or more pods 126, one or more containers 128, one or more kubelets 130 (e.g., running on a network node 16 such as via processing circuitry 68), and/or one or more kube-proxies 132. Kubelet 130 may be referred to as a node agent. Although a container 128 is shown as being within a pod 126, the container 128 is not limited as such and may reside (e.g., run) anywhere within a worker node 124. For ease of understanding, arrows corresponding to some connections/communication between elements of the Kubernetes architecture are shown, it is understood than any element may communicate with any other element shown in FIG. 8 or any other element, either directly or indirectly.

Further, any one of the Kubernetes elements described above may be and/or be part of and/or be within and/or perform the method/steps/features according to network node 16 and/or any of the elements of network node 16 (e.g., shown in FIG. 3) such as hardware 58 and/or processing circuitry 68. Similarly, any one of the Kubernetes elements described above may be and/or be part of and/or be within and/or run according to WD 22 and/or any of the elements of network node 16 (e.g., shown in FIG. 3) such as hardware 80 and/or processing circuitry 84. Further, any one of the Kubernetes elements described above may be and/or be part of and/or be within and/or run according to host computer 24 and/or any of the elements of network node 16 (e.g., shown in FIG. 3) such as hardware 38 and/or processing circuitry 42. Put differently, network node 16 is equipped with hardware 58 (and/or its components) and/or software 74 configured to run Kubernetes (and/or any Kubernetes component) and/or any other container orchestration system (e.g., a local container orchestration system).

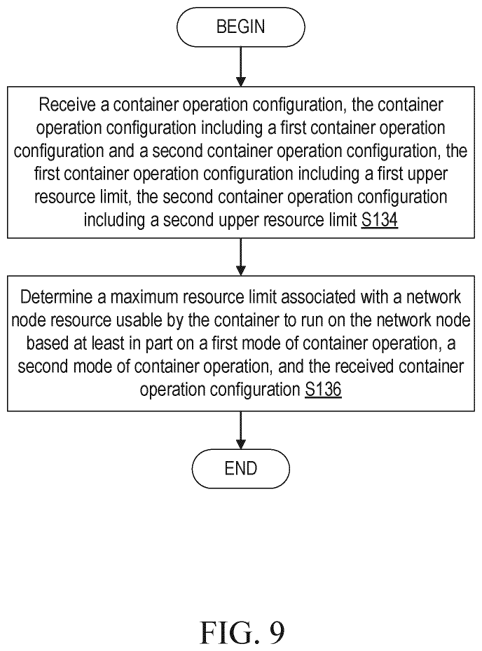

FIG. 9 is a flowchart of an example process in a network node 16 for determining a maximum resource limit associated with a network node resource usable by a container 128 to run on the network node 16. One or more blocks described herein may be performed by one or more elements of network node 16 such as by one or more of processing circuitry 68 (including the node resource unit 32), processor 70, communication interface 60 and/or radio interface 62. Network node 16 such as via processing circuitry 68 and/or processor 70 and/or communication interface 60 and/or radio interface 62 is configured to receive (Block S134) a container operation configuration. The container operation configuration includes a first container operation configuration and a second container operation configuration. The first container operation configuration includes a first upper resource limit 140, and the second container operation configuration includes a second upper resource limit 142. Network node 16 such as via processing circuitry 68 and/or processor 70 and/or communication interface 60 and/or radio interface 62 is configured to determine (Block S136) a maximum resource limit associated with a network node resource usable by the container 128 to run on the network node 16 based at least in part on a first mode of container operation 146a, a second mode of container operation 146b, and the received container operation configuration.

In some embodiments, the first mode of container operation 146a is a startup phase of the container 128, and the second mode of container operation 146b is a runtime phase of the container 128.

In some other embodiments, the processing circuitry 68 is further configured to determine that the container 128 is operated in any one of the first mode of container operation 146a and the second mode of container operation 146b based, at least in part, on probe information.

In an embodiment, the processing circuitry 68 is further configured to determine that the maximum resource limit equals any one of the first upper resource limit 140 of the first container operation configuration when the container 128 is operated in the first mode of container operation 146a; and the second upper resource limit 142 of the second container operation configuration when the container 128 is operated in the second mode of container operation 146b. The first upper resource limit 140 is one of equal to and greater than the second upper resource limit 142.

In another embodiment, the second mode of container operation 146b causes at least a portion of the network node resource usable by the container 128 during the first mode of container operation 146b to become available.

In some embodiments, the container operation configuration is part of a modified container resource model.

In some other embodiments, the processing circuitry 68 is further configured to manage the lifecycle of the container 128 based on the determined maximum resource limit. Managing the lifecycle of the container 128 includes any one of starting the container 128 and running the container 128.

In an embodiment, the network node resource usable by the container 128 to run on the network node 16 includes any one of a processor 70 and a memory 72.

In another embodiment, the container 128 is associated with a pod 126.

In some embodiments, the network node 16 includes a Kubernetes kubelet running on a Kubernetes worker node 124, the network node resource is a node resource associated with the Kubernetes worker node 124, and the container 128 is configured by a Kubernetes scheduler 120 to run on the network node 16.

Having described the general process flow of arrangements of the disclosure and having provided examples of hardware and software arrangements for implementing the processes and functions of the disclosure, the sections below provide details and examples of arrangements for resource limits specification for orchestration systems such as container orchestration systems.

In some embodiments, a resource model (e.g., a container resource model, a pod resource model) is described. The resource model may be API based. The resource model is enriched (e.g., modified) with configuration parameters may depend on (e.g., be a function of) a status such as workload status. The status may be determined from probe information, e.g., received from a probe such as a startup probe, a readiness probe, and/or any other probe or information source that provides information about the status. In some other embodiments, if the configuration parameters are not present, available, and/or determinable (e.g., from the resource model), the configuration parameters may be determined (e.g., taken) from corresponding resource limits (e.g., configured in an existing resource model).

In some other embodiments, a scheduler 120 (e.g., belonging to a control plane 122) and/or a kubelet 130 are used. In a nonlimiting example, a network node 16 (e.g., a kubelet 130 running on a worker node 124) receives, such as via communication interface 60, a container operation configuration (e.g., from another network node 16 such as scheduler 120). The container operation configuration may include a first container operation configuration and/or a second container operation configuration. The first container operation configuration includes a first upper resource limit, and the second container operation configuration includes a second upper resource limit. The network node 16 may determine a maximum resource limit associated with a network node resource usable by a container 128 to run on the network node 16 based at least in part on a first mode of container operation, a second mode of container operation, and the received container operation configuration. In some embodiments, the network node 16 may be the worker node 124 that includes the kubelet 130 and/or the container 128 and/or a corresponding pod 126.

The container operation configuration may include multiple configuration parameters, which may be introduced (i.e., configured, relayed, communicated, implemented, etc.) using multiple methods/steps/processes. A nonlimiting example includes the following parameters:

| resources: | |
|---|---|
| limits: | |
| cpu: 400m | |
| memory: 1024Mi | |
| startupLimits: | # name is indicative |

```
    cpu: 900m
    memory: 1024Mi
requests:
  cpu: 200m
  memory: 512Mi
```

In this nonlimiting example, at startup a container is given an additional allocation of resources (e.g., an extra half (500 m) CPU). The additional resources may be allocated until an event occurs (e.g., a pod 126 is ready). The configuration parameters startupLimits cpu, and/or memory are indicative.

In an embodiment, a Helm chart (i.e., a tool for managing Kubernetes packages) may be used. When part of a Helm chart, the above configuration (i.e., configuration parameters) may be conveniently wrapped into a conditional statement, which may also be indicative along with configuration parameters startupLimits cpu, and/or memory. In the following nonlimiting example, a template “eric-oss.startuplimits.enabled” is first evaluated and/or set “true” for Kubernetes clusters (e.g., supporting the principles of the present disclosure). Otherwise, the template may be set to false and/or the corresponding configuration respectively applied or not.

```
  resources:
    limits:
      cpu: 400m
      memory: 1024Mi
{{ $startup : = include “eric-oss.startuplimits.enabled”. }} # indicative
{{ if eq $startup “true” -}}
```

| | |
|---|---|
| startupLimits: | # name is indicative |

```
      cpu: 900m
      memory: 1024Mi
{{ - end }}
  requests:
    cpu: 200m
    memory: 512Mi
```

In another embodiment, a process flow (e.g., to determine a maximum resource limit associated with a network node resource usable by the container 128 to run on the network node 16) is as follows:
A workload (i.e., a container 128, a pod 126) where startupResources are specified is deployed.
A request may be managed by a scheduler 120 which may find a worker node 124 (e.g., to allocate the workload).
A container 128 and/or pod 126 is started by kubelet 130 on the chosen worker node 124, thereby enforcing startup resource limits.
Until the pod 126 (and/or container 128) is ready (i.e., becomes ready, is ready to run), startup resource limits may be enforced.
When the pod 126 (and/or container 128) is ready, other resource limits (e.g., running resource limits) are enforced.

In some embodiments, resource limits and/or requests may be referred to as container properties. Pods 126 may refer to an indivisible plurality of containers. In Kubernetes, a pod 126 may be ready when (e.g., only when) the containers (e.g., all containers of the pod) are ready. Ready, e.g., in Kubernetes context, may refer to exactly “ready to accept traffic”. Readiness probe(s) may be used by any of the processes/steps/features of the present disclosure, e.g., to determine at least one container 128 is ready.

In some other embodiments, a container runtime may alter at run-time the CPU limit dedicated to the running container. In this case, the container 128 (and/or pod 126) runs with usual resource limits which are, in some cases, tighter than startup resource limits. In other words, CPU limit is reduced. If the container runtime cannot change the resources dedicated to the running container (e.g., unless the container is restarted), the container 128 (and/or pod 126) may keep running based on the startup resource limits.

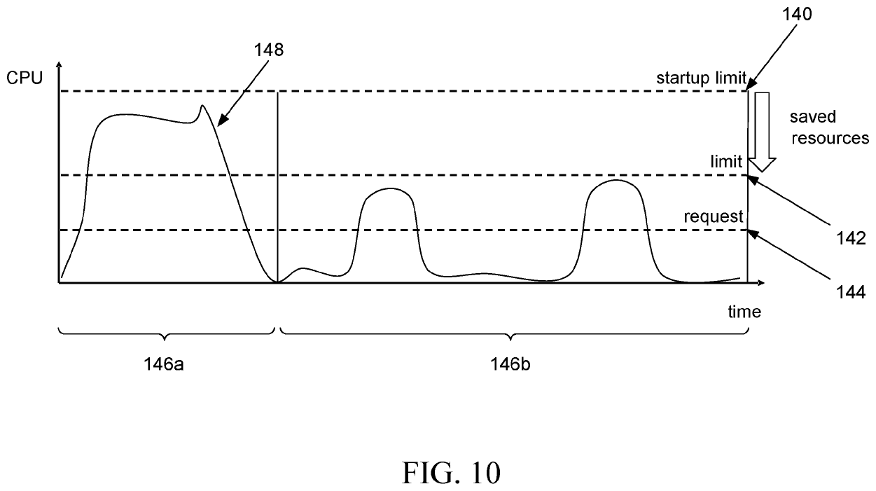

In an embodiment, a custom controller via a Custom Resource Definition (CRD), e.g., in Kubernetes, that monitors the container 128 (and/or pod 126) specified in terms of startup CPU limits, captures violations, and/or performs data analysis (e.g., so the DevOps engineer can take further actions such as increase the CPU limit). FIG. 10 is a time plot showing multiple example modes of container operation 146. More specifically, the time plot shows a first upper resource limit 140 (e.g., startup limit) being assigned (e.g., as a maximum resource limit) to a CPU during a first mode of container operation 146a and second upper resource limit 142 (e.g., limit) being assigned (e.g., as the maximum resource limit) to the CPU during a second mode of container operation 146b according to some embodiments of the present disclosure. A resource usage 148 (e.g., CPU usage) and a request 144 (i.e., a request limit) are also shown. Each mode of container operation 146 may be determined based on probe information. For example, the first mode of container operation 146a may be determined based on probe information from a readiness probe (i.e., indicating “OFF”, false, etc.) and/or indicating that the container 128 and/or pod 126 are in the first mode of container operation 146a (e.g., startup, startup phase). Similarly, the second mode of container operation 146b may be determined based on probe information from a readiness probe (i.e., indicating “ON”, true, etc.) and/or indicating that the container 128 and/or pod 126 are in the second mode of container operation 146b (e.g., runtime, runtime phase).

In some embodiments, probe information include “startup” probe, “readiness” probe, other Kubernetes probes and non-Kubernetes probes, such as “command that is exploited by the container orchestration system to understand that the container is alive and ready to receive traffic.”

In some other embodiments, when the container operation configuration does not include a second upper resource limit, the first upper resource limit may be used as the maximum resource limit for the second mode of container operation, e.g., as a runtime resource limit, e.g., to provide backward compatibility.

In an embodiment, a pod footprint is a sum of the footprint of each of the containers associated with the pod. In another embodiment, a 1:1 correspondence between pod and containers is used.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

### Abbreviations that May be Used in the Preceding Description Include

API Application Programming Interface
CRD Custom Resource Definition
CPU Central Processing Units
k8s Kubernetes
RAM Random Access Memory

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to manage a lifecycle of a container configurable to run on the network node, the network node comprising:
a communication interface configured to:
receive a container operation configuration, the container operation configuration including a first container operation configuration and a second container operation configuration, the first container operation configuration including a first upper resource limit, the second container operation configuration including a second upper resource limit; and
processing circuitry in communication with the communication interface, the processing circuitry configured to:
determine a maximum resource limit associated with a network node resource usable by the container to run on the network node based at least in part on a first mode of container operation, a second mode of container operation, and the received container operation configuration.

2. The network node of claim 1, wherein the first mode of container operation is a startup phase of the container, and the second mode of container operation is a runtime phase of the container.

3. The network node of claim 1, wherein the processing circuitry is further configured to:
determine that the container is operated in any one of the first mode of container operation and the second mode of container operation based, at least in part, on probe information.

4. The network node of claim 1, wherein the processing circuitry is further configured to:
determine that the maximum resource limit equals any one of:
the first upper resource limit of the first container operation configuration when the container is operated in the first mode of container operation; and
the second upper resource limit of the second container operation configuration when the container is operated in the second mode of container operation, the first upper resource limit being one of equal to and greater than the second upper resource limit.

5. The network node of claim 1, wherein the second mode of container operation causes at least a portion of the network node resource usable by the container during the first mode of container operation to become available.

6. The network node of claim 1, wherein the container operation configuration is part of a modified container resource model.

7. The network node of claim 1, wherein the processing circuitry is further configured to:
manage the lifecycle of the container based on the determined maximum resource limit, managing the lifecycle of the container including any one of starting the container and running the container.

8. The network node of claim 1, wherein the network node resource usable by the container to run on the network node includes any one of a processor and a memory.

9. The network node of claim 1, wherein the container is associated with a pod.

10. The network node of claim 1, wherein the network node includes a Kubernetes kubelet running on a Kubernetes worker node, the network node resource is a node resource associated with the Kubernetes worker node, and the container is configured by a Kubernetes scheduler to run on the network node.

11. A method implemented in a network node configured to manage a lifecycle of a container configurable to run on the network node, the method including:
receiving a container operation configuration, the container operation configuration including a first container operation configuration and a second container operation configuration, the first container operation configuration including a first upper resource limit, the second container operation configuration including a second upper resource limit; and
determining a maximum resource limit associated with a network node resource usable by the container to run on the network node based at least in part on a first mode of container operation, a second mode of container operation, and the received container operation configuration.

12. The method of claim 11, wherein the first mode of container operation is a startup phase of the container, and the second mode of container operation is a runtime phase of the container.

13. The method of claim 11, wherein the method further includes:
determining that the container is operated in any one of the first mode of container operation and the second mode of container operation based, at least in part, on probe information.

14. The method of claim 11, wherein the method further includes:
determining that the maximum resource limit equals any one of:
the first upper resource limit of the first container operation configuration when the container is operated in the first mode of container operation; and
the second upper resource limit of the second container operation configuration when the container is operated in the second mode of container operation, the first upper resource limit being one of equal to and greater than the second upper resource limit.

15. The method of claim 11, wherein the second mode of container operation causes at least a portion of the network node resource usable by the container during the first mode of container operation to become available.

16. The method of claim 11, wherein the container operation configuration is part of a modified container resource model.

17. The method of claim 11, wherein the method further includes:
managing the lifecycle of the container based on the determined maximum resource limit, managing the lifecycle of the container including any one of starting the container and running the container.

18. The method of claim 11, wherein the network node resource usable by the container to run on the network node includes any one of a processor and a memory.

19. The method of claim 11, wherein the container is associated with a pod.

20. The method of claim 11, wherein the network node includes a Kubernetes kubelet running on a Kubernetes worker node, the network node resource is a node resource associated with the Kubernetes worker node, and the container is configured by a Kubernetes scheduler to run on the network node.
